(19) United States
(12) Patent Application Publication
(10) Pub. No.: US 2003/0042445 A1
(43) Pub. Date: Mar. 6, 2003

(54) Apparatus for reading storage layer radiation screens

(76) Inventors: Christopher R. Mitchell, Pleasanton, CA (US); Gregory A. Sprehn, Livermore, CA (US); Stephan Hoffmann, Oakland, CA (US); Joseph R. Rimsa, Milpitas, CA (US)

Correspondence Address: WILSON SONSINI GOODRICH & ROSATI, 650 PAGE MILL ROAD, PALO ALTO, CA, 943041050

(21) Appl. No.: 09/944,063

(22) Filed: Aug. 30, 2001

(51) Int. Cl. G03B 42/08

(52) U.S. Cl. 250/584

(57) ABSTRACT

An apparatus is provided for reading a latent image stored on a storage layer radiation screen, the apparatus comprising: a light source adapted to provide excitation light across a width of a storage layer radiation screen; and an excitation and image acquisition station comprising a mechanism for shaping the excitation light as an elongated region of excitation light across the width of the screen, optics for collecting a region of light emitted by a lateral strip of the screen excited by the elongated region of excitation light, and an elongated pixelated sensor array positioned to capture from the optics the region of light emitted by the screen; wherein the latent image stored on the screen is read by collecting and capturing light emitted from the screen as the screen moves past the excitation and image acquisition station.

### FIELD OF THE INVENTION

The present invention relates to an apparatus for imaging latent images stored on a storage layer radiation screen.

### DESCRIPTION OF RELATED ART

X-ray radiography has proved to be an important tool in the detection of many diseases. In recent years, a number of technical advances have enabled the development of digital radiographic imaging systems, replacing in many cases the fluorescent screens and film traditionally used. Mammography is a notable exception, with only one full-field digital mammography (FFDM) system currently approved by the US FDA (United States Food & Drug Administration) and a handful of other systems at various stages in the approval process.

There are several reasons for the slow transition from film-screen to digital mammography. Uncertainty on the part of government approval bodies of the requirements for digital mammography has slowed the transition. It is not enough to be simply “equivalent to film.” For example, the spatial resolution of film-screen mammography is excellent, often exceeding 16 line pairs per millimeter. Studies by one manufacturer showed that with only 5 line pairs per millimeter and the excellent contrast and noise performance of a digital system that detection of disease and features of interest was comparable to film.

The high cost of digital mammography equipment has also slowed the transition. To date, the cost of digital mammography equipment has not been well-supported by insurance reimbursement structures.

Mammography is also inherently technically challenging. Indications of disease are often subtle because of small size and/or x-ray absorption characteristics similar to normal tissue. This necessitates a high level of performance from the x-ray imaging system.

Several different approaches to digital mammography have been proposed including: the use of solid state detector arrays and charge-coupled devices (CCDs). Examples of digital imaging systems attempting to provide for full field, single exposure breast imaging include those described in U.S. Pat. Nos. 6,005,911, 5,988,802, 5844,242, 5801,385.

In other fields of medical imaging, particularly dental, storage layer radiation screens have begun to replace conventional x-ray films. Storage layer radiation screens have the significant advantages over traditional x-ray film of requiring lower levels of x-ray radiation to produce radiation images, and are reusable after an erasing and sterilization process. A typical storage layer radiation screen can be used for recording images of an object, such as a part of human body, exposed to radiation. The screen is then read by scanning the screen with stimulating light, such as a laser beam. This causes the storage elements in the screen, typically phosphors, to emit light in proportion to the amount of radiation absorbed by the portion of the screen being scanned. The light emitted from the screen is then detected and converted into electrical signals. The electrical signals are then used to reproduce the latent radiation image as a visible image. Examples of storage layer radiation screen reading systems are described in U.S. Pat. Nos. 4,973,134, 4,543,479, 4,582,989, and 5,635,728.

Current storage layer screen reading devices scan an excitation light source over the surface of the storage layer screen. Non-imaging, but relatively efficient collection optics are then used to gather emitted light as the excitation light is scanned across the storage layer screen. The collected light is converted to electrical signals and amplified, typically using photomultiplier tubes. The output of the photomultiplier tube is typically further amplified and digitized. By this process, the image is reconstructed by correlating the digitized output of the photomultiplier tube with the region of the screen from which the emitted light originated.

System resolution in these devices depends primarily on screen type, and the size, power density and dwell time of the scanning excitation spot. Spot size must be limited to avoid exciting f-centers outside a pixel. Scatter of the excitation light within the screen is a dominant resolution limiting process of the screen. Increasing power density and/or dwell time increase the probability of scattered excitation light releasing f-centers that are outside the pixel currently under view. These incidental emissions are either absorbed and lost or are collected out of sequence and contribute to blurring. Additionally, there are f-centers within the pixel that are left unread due to incomplete excitation. Any attempt to increase the efficiency of the excitation process to improve the image signal-to-noise level results in detrimental blurring and loss of resolution. Thus current methods are limited to choosing between resolution and higher signal.

The present invention addresses the various problems related to the use of either traditional x-ray film or digital imaging systems in high sensitivity applications such as mammography by providing a system adapted for reading storage layer radiation screens which provides improved imaging performance.

### SUMMARY OF THE INVENTION

An apparatus for reading a latent image stored on a storage layer radiation screen is provided. In one embodiment, the apparatus comprises: a light source adapted to provide excitation light across a width of a storage layer radiation screen; and an excitation and image acquisition station comprising a mechanism for shaping the excitation light as an elongated region of excitation light across the width of the screen, optics for collecting a corresponding region of light emitted by a lateral strip of the screen excited by the elongated region of excitation light, and an elongated pixelated sensor array positioned to capture from the optics the elongated region of light emitted by the screen; wherein the latent image stored on the screen is read by collecting and capturing light emitted from the screen as the screen moves past the excitation and image acquisition station.

In another embodiment, the apparatus comprises: a platform comprising a mechanism for causing a storage layer radiation screen comprising a latent radiation image to move from a proximal side to a distal side of the platform; a light source adapted to provide excitation light across a width of the screen; and an excitation and image acquisition station positioned adjacent the platform, the station comprising a mechanism for shaping the excitation light as an elongated region of excitation light across the width of the screen, optics for collecting a corresponding region of light emitted by a lateral strip of the screen excited by the elongated region of excitation light, and a 1×n dimensioned elongated pixelated sensor array positioned to capture from the optics the elongated region of light emitted by the screen; wherein the latent image stored on the screen is read by collecting and capturing light emitted from the screen as the screen moves past the excitation and image acquisition station.

In another embodiment, the apparatus comprises: a platform comprising a mechanism for causing a storage layer radiation screen comprising a latent radiation image to move from a proximal side to a distal side of the platform; a light source adapted to provide excitation light across a width of the screen; and an excitation and image acquisition station positioned adjacent the platform, the station comprising a mechanism for shaping the excitation light as an elongated region of excitation light across the width of the screen, optics for collecting light emitted by a corresponding region of the screen excited by the region of excitation light, and an m×n pixelated sensor array positioned to capture from the optics the region of light emitted by the screen; wherein the latent image stored on the screen is read by collecting and capturing light emitted from the screen as the screen moves past the excitation and image acquisition station in a time-delay integration mode.

In another embodiment, the apparatus comprises: a platform comprising a mechanism for causing a storage layer radiation screen comprising a latent radiation image to move from a proximal side to a distal side of the platform; a light source adapted to provide excitation light across a width of the screen; and an excitation and image acquisition station positioned adjacent the platform, the station comprising a mechanism for shaping the excitation light as an elongated region of excitation light across the width of the screen, optics for collecting the light emitted by a corresponding region of the screen excited by the elongated region of excitation light, and an elongated m×n pixelated sensor array positioned to capture from the optics the region of light emitted by the screen; wherein the latent image stored on the screen is read by collecting and capturing light emitted from the screen as the screen moves past the excitation and image acquisition station in a step-and-repeat mode.

In another embodiment, the apparatus comprises: a rotatable drum on which a storage layer radiation screen comprising a latent radiation image may be positioned; a light source adapted to provide excitation light across a width of the screen; and an excitation and image acquisition station positioned adjacent to the rotatable drum, the station comprising a mechanism for shaping the excitation light as an elongated region of excitation light across the width of the screen, optics for collecting a corresponding region of light emitted by a lateral strip of the screen excited by the elongated region of excitation light, and a 1 x n elongated pixelated sensor array positioned to capture from the optics the region of light emitted by the screen; wherein the latent image stored on the screen is read by collecting and capturing light emitted from the screen as the rotatable drum rotates and causes the screen to move past the excitation and image acquisition station.

A method is also provided for reading a latent image stored on a storage layer radiation screen. In one embodiment, the method comprises: delivering an elongated region of excitation light; moving a storage layer radiation screen past the elongated region of excitation light, the elongated region of excitation light causing light to be emitted from the screen corresponding to portions of the latent image stored on the screen; employing optics to collect light emitted from the storage layer radiation screen as the screen is moved past the region of excitation light; and focusing the collected light from the optics on an elongated pixelated sensor array positioned to capture from the optics the region of light emitted by the screen.

It is noted in regard to all of the above apparatus and method embodiments that the elongated region of excitation light and the resulting region of light emitted by the screen are intended to be approximately rectangular in the sense that the smaller dimension (e.g. width) of the elongated region is roughly uniform across the longer dimension (e.g., length) of the elongated region. Variations in the width of the elongated region such that the elongated sides are not perfectly linear are less preferred but do not cause the region to be outside of the definition of an elongated region. It is also noted in regard to all of the above embodiments that the precise shape of the opposing narrow ends of the elongated region need not necessarily be straight and/or parallel to each other. Rather, the shape of the region should be judged based on the shape of the elongated sides of the region.

It is also noted in regard to all of the above embodiments that the elongated region is preferably narrow across in smaller dimension and may be as little as 1, 2, 3, 4, 5, 6, 7, 8, 9, or 10 pixels wide across in smaller dimension.

Unless otherwise specified, in regard to the any of the above embodiments, the pixelated sensor array may be a m×n array where m is 1, 2, 3, 4, 5, 6, 7, 8, 9, 10 or more pixels wide and n is greater than 1 and larger than m. In one variation, n is at least 2048. In particular variations, m=1 or 2 and n is at least 2048.

In regard to the any of the above embodiments, the pixelated sensor array may be a CMOS sensor array and is optionally optimized for detection of light at the emission wavelength. Optionally, the CMOS sensor array is optimized such that its sensitivity to the excitation wavelength and infrared is minimized. It is beleived that the same fabrication techniques which maximize detection of light at the emission wavelength simultaneously reduce sensitivity to the excitation and infrared wavelengths.

In regard to the any of the above embodiments, the apparatus may comprise at least two CMOS sensor arrays positioned in parallel with each other, at least one of which serving as the pixelated sensor array. The region of light collected by the optics may be focused upon one or both of the two CMOS sensor arrays.

When the pixelated sensor array is a CMOS sensor array, the excitation and image acquisition station may further comprise a filter which filters light other than light emitted by the screen from the CMOS sensor array.

In regard to any of the above embodiments, the light source may be a broad band light source. A filter may optionally be employed with the broad band light source which removes light that does not fall within a wavelength range of an absorption spectrum of the screen.

In regard to any of the above embodiments, the excitation light contacting the screen may optionally comprise the wavelength range of 500 to 1000 nanometers.

In regard to any of the above embodiments, the elongated region of excitation light may have a width of less than 100 μm, or 80 μm, or 60 μm.

Also in regard to any of the above embodiments, the excitation and image acquisition station may comprise a cylindrical lens which functions to sharpen the focus of the excitation light. A flange may also be used which functions to create a sharp leading edge of the excitation light.

Also in regard to any of the above embodiments, the excitation and image acquisition station may be designed so as to excite a lateral strip of the screen having of width of less than 100 μm at any instant.

Also in regard to any of the above embodiments, the screen may be moved past the excitation light by moving the screen over a surface of a platform. The screen may also be moved past the excitation light by rotating a rotatable drum on which the screen is positioned.

### BRIEF DESCRIPTION OF THE DRAWINGS

FIG. 1 illustrates a top down view of a system for reading storage layer radiation screens according to the present invention.

FIG. 2 illustrates a side view of the system appearing in FIG. 1.

FIG. 3 illustrates a broad band light source which produces light over a range of wavelengths including light which falls within the wavelength range that is effectively absorbed by the storage layer radiation screen (absorption spectrum) as well as light at wavelengths that is outside the absorption range of the screen.

FIG. 4 illustrates an embodiment of a light source incorporating a filter which may be used in conjunction with the present invention.

FIG. 5 provides a close-up view of the excitation and image acquisition station shown in FIGS. 1 and 2.

FIG. 6A illustrates a first side view of an embodiment of an excitation and image acquisition station.

FIG. 6B illustrates a second side view of an embodiment of an excitation and image acquisition station.

FIG. 6C illustrates a first instance where a first line CMOS sensor array is aligned with the light emitted by the narrow strip of the screen.

FIG. 6D illustrates a second instance where a first line CMOS sensor array is aligned with the light emitted by the narrow strip of the screen.

FIG. 6E illustrates an instance where a first line CMOS sensor array is not aligned with the light emitted by the narrow strip of the screen.

FIG. 6F illustrates an alternate embodiment for detecting misalignments in which only a single CMOS sensor array is used.

FIG. 6G illustrates an alternate embodiment for detecting misalignments in which only a single CMOS sensor array is used.

FIG. 7 illustrates an embodiment of a drum scanner according to the present invention.

FIG. 8 illustrates an embodiment of the invention which comprises a radiation source, a platform on which a breast may be positioned, and an apparatus according to the present invention.

### DETAILED DESCRIPTION OF THE INVENTION

The present invention relates to a system for reading storage layer radiation screens. One particular application for the present invention is its use in mammography which requires greater signal sensitivity.

One feature of the present invention which provides greater signal sensitivity relates to providing a higher level of excitation to the screen in order to more fully stimulate emission. In this regard, the excitation energy is simultaneously applied to a rectangular region (optionally a 1 pixel wide line) on the storage layer screen for a period of time which allows a higher amount of energy stored on the screen to be released. The emitted light is collected with imaging optics coupled to an integrating, imaging detector. The signals from the detector are read out, amplified and digitized.

By more completely collecting and capturing energy stored on storage layer radiation screens, the device of the present invention is able to achieve greater signal sensitivity than previous storage layer radiation screen reading systems. In one embodiment, at least 1%, 2%, 3% or more of the energy stored on a storage layer radiation screen is released, collected and captured by a device according to the present invention.

As will be described herein in greater detail, the storage layer radiation screen reading system of the present invention provides greater signal sensitivity than previous storage layer radiation screen reading systems and is thus compatible for use in mammography as well as in other radiographic applications, which include chest, extremity, dental, and industrial radiographic procedures.

Any storage layer radiation screen may be used in conjunction with the screen reading system according to the present invention. The storage layer radiation screen may be formed of any compound which absorbs radiation, such as x-rays, alpha.-rays, beta.-rays, cathode rays and ultraviolet rays, and which stores a latent image that is proportional to the incident radiation field, and which, when excited by suitable electromagnetic wave radiation, emits electromagnetic wave radiation of a different frequency.

In one embodiment, the storage layer radiation screens used in combination with the devices of the present invention comprises a binderless array of phosphor crystals. Several different examples of storage phosphors which have been formed into a binderless array of phosphor crystals have been described and may be used in the present invention. For example, Leblans, et al. describes binderless storage phosphor screens including RbBr:Tl⁺ and CsBr:Eu²⁺ have been grown as needles and arrayed into a storage layer radiation screen. See Leblans, Paul J. R.; Struye, Luc; Willems, Peter; “New needle-crystalline CR detector,” Medical Imaging 2001: Physics of Medical Imaging, Proceedings of SPIE Vol. 4320, Feb. 18-20, 2001, San Diego, Calif., pp. 59-67. Published PCT No. WO 01/03156 describes CsX:Eu stimulable phosphors where X represents a halide selected from the group consisting of Br, Cl and combinations thereof. U.S. Pat. No. 5,736,069 describes a class of alkali metal storage phosphors. EP-A-174,875 and EP-B-252,991 and U.S. Pat. No. 5,028,509 describe another class of a class of alkali metal storage phosphors. In U.S. Pat. No. 5,055,681, a binderless screen comprising the phosphor as disclosed in U.S. Pat. No. 5,028,509 has been disclosed.

In one variation, the binderless array of phosphor crystals comprise columnar or needle-like crystals. Such arrays are described, by way of example, in EP-A-185-534, U.S. Pat. Nos. 4,769,549, 4,947,046 and 5,055,681, JP-A-61 245099 and Published PCT No. WO 01/03156.

It is noted that the above references are provided by way of example and that any storage layer radiation screens which incorporates a binderless array of phosphor crystals may be employed and are intended within the scope of the invention.

Without being bound by theory, it is believed that binderless storage layer radiation screens and more preferably binderless screens which comprise an array of columnar or needle-like crystals, have reduced light scattering within the screen and thus may be excited at greater power density and/or for a longer period of time than storage layer phosphor screens where the phosphor crystals are a powder suspended in a binder material. This implies that the excitation light may be applied at increased power and/or for longer times, without the concomitant premature screen erasure observed in phosphor screens comprising powder suspended in a binder material. This further implies the opportunity for more complete reading of the energy stored in the screens since both the excitation light and the emitted light are contained within the field of view of the collection optics and detector. This approach both preserves spatial resolution as well as minimizes unwanted screen erasure.

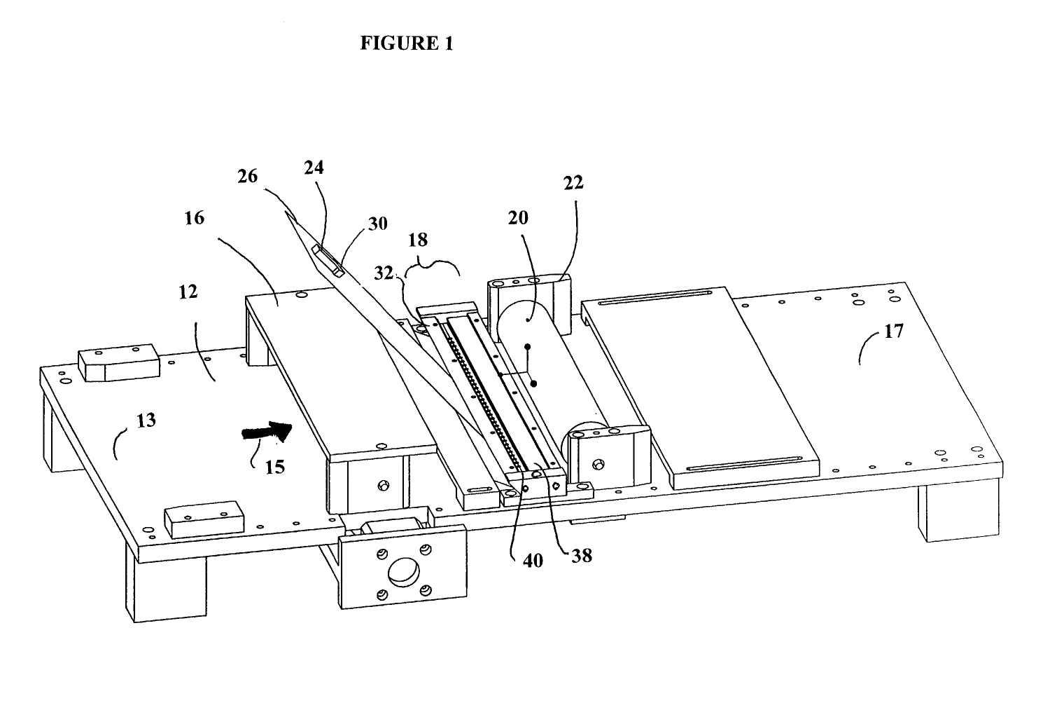

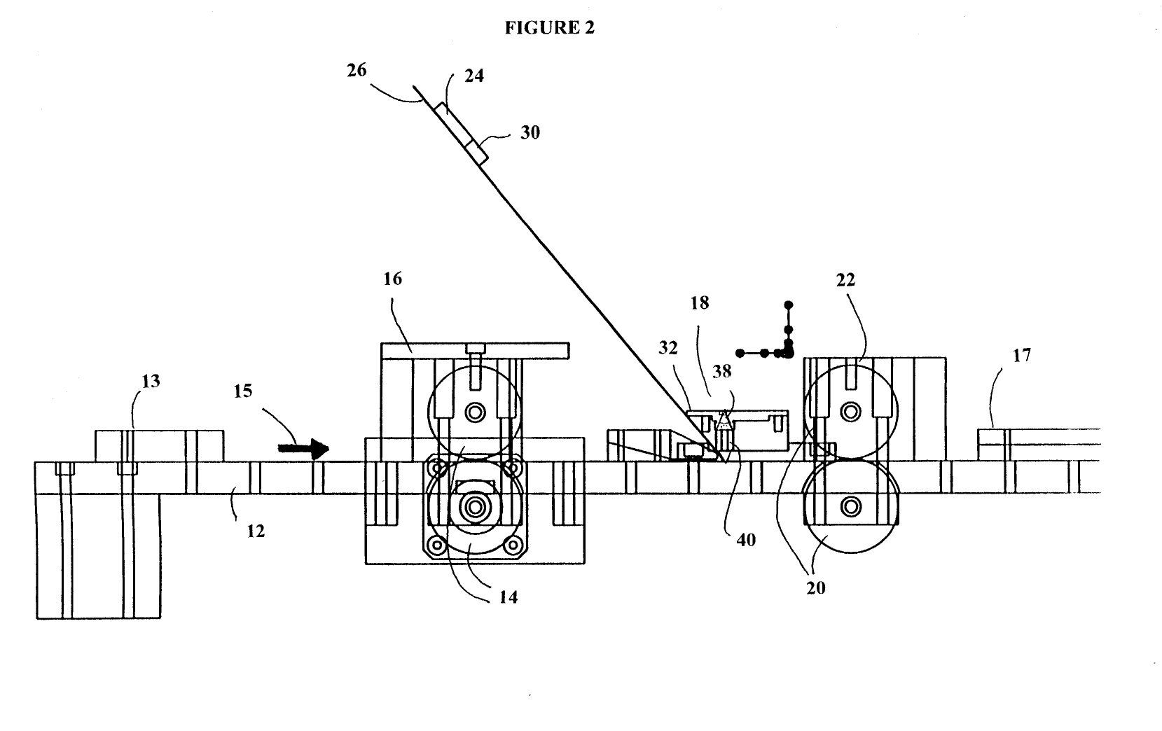

FIG. 1 illustrates a top down view of a system for reading storage layer radiation screens according to the present invention. FIG. 2 illustrates a side view of the system appearing in FIG. 1. As illustrated, the system comprises a platform 12 on which a storage layer radiation screen comprising a latent radiation image is moved through the system. The storage layer radiation screen (not shown) is introduced into the system on a proximal side 13 of the platform. The screen then moves through the system and exits the system on a distal side 17 of the platform.

Rollers 14 positioned in roller assembly 16 cause the storage layer radiation screen to move: from the proximal side of the platform 13 in the direction shown by arrow 15 to the excitation and image acquisition station 18. Meanwhile, rollers 20 positioned in roller assembly 22 cause the storage layer radiation screen to move away from the excitation and image acquisition station 18 toward the distal side of the platform 12. This allows another screen to be added to the system and read.

It is noted that the rollers and roller station may be substituted for any mechanism useful in transporting a storage layer radiation screen within the overall system past the excitation and image acquisition station 18. For example, a belt system may also be employed.

It is important for proper excitation and image acquisition that the surface of the storage layer radiation screen be maintained at a relatively fixed distance relative to the detectors and the excitation light source. The mechanisms used to transport the storage layer radiation screen past the excitation and image acquisition station 18, shown in FIGS. 1 and 2 as roller assemblies 16, 22 may be used to help maintain consistent separation distances between the surface of the storage layer radiation screen and the detectors and the excitation light source.

Shown positioned over the excitation and image acquisition station 18 is a light source 24 which produces the light energy used to excite the storage layer radiation screen.

The light source should be intense enough, relative to the dwell time of the excitation light relative to a given pixel (as affected by the screen transport speed and the pixel integration time), to cause a large amount of the energy stored at that pixel to be released. It is noted that the time it takes to discharge any given percentage of the f-centers is a function of excitation light intensity, the appropriateness of its wavelength, and the dwell lime of the excitation light on the screen. The speed of the screen relative to the light source and the detector is preferably controlled such that f-centers on the screen in the field of view of the detector are excited sufficiently to discharge the majority of them. At the same time, the integration time of the detector should be set to maximize the recording of the signal from those f-centers. The integration time of the detector should be much longer than the detector read-out time.

Light sources which may be used in conjunction with the present invention may be any device which is capable of producing light energy whose wavelength(s) are capable of being absorbed by the storage layer of the screen and which can deliver sufficient power to the screen without illuminating the screen in regions not in the view of the optical collection system. Because the latent image is read destructively, i.e. erased upon reading, it is important that the screen not be illuminated in regions that have not been viewed by the detector system. Lasers, such as HeNe or diode lasers have been typically used to excite storage layer radiation screens. In one embodiment, a diode laser is used in combination with an optical system, such as a line generator, which converts the pencil beam native to the diode laser into a uniform line.

The wavelength of the light used should be well matched to the absorption of the storage layer material. For most storage layer material currently in use, the optimum wavelengths are in the range of 630 to 700 nm. This wavelength may change as different storage layer materials are developed and thus the particular wavelength should not depart from the present invention.

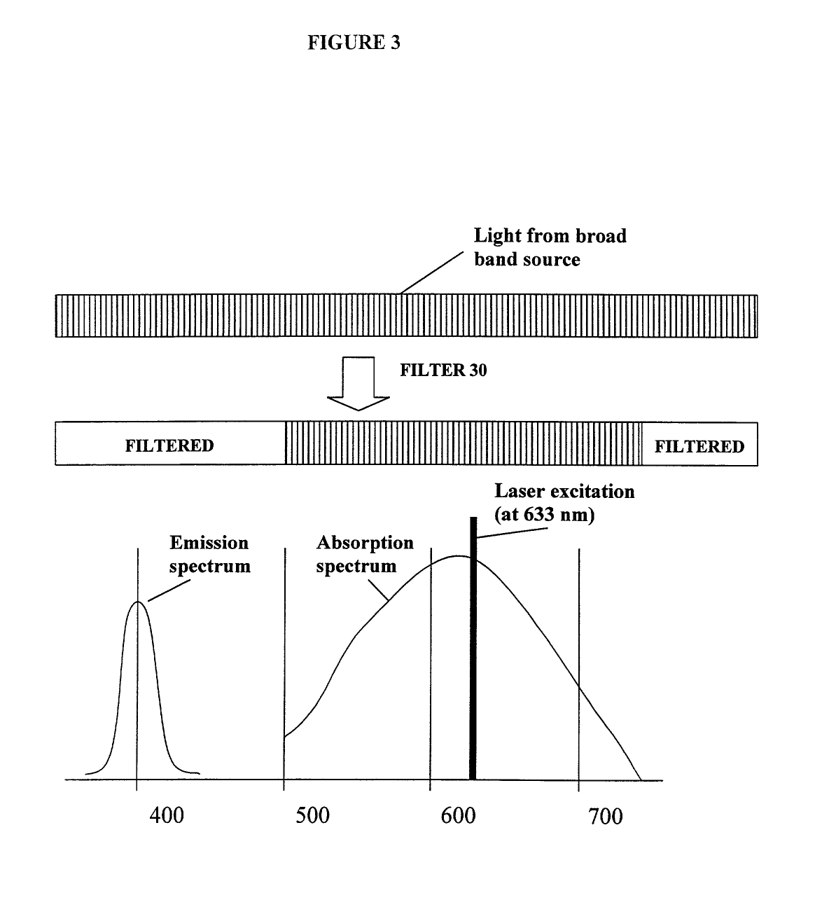

By contrast to the use of lasers which emit light at a specific wavelength as a light source, a broad band light source may be employed in combination with a filter. As illustrated in FIG. 3, a broad band light source produces light over a range of wavelengths including light which falls within the wavelength range that is effectively absorbed by the storage layer radiation screen (absorption spectrum) as well as light at wavelengths that is outside the absorption range of the screen. By using a filter 30, light that does not fall within the wavelength range that is effectively absorbed by the screen can be removed. Meanwhile, light that does fall within the wavelength range that is effectively absorbed by the screen is allowed to contact and excite the storage layer radiation screen.

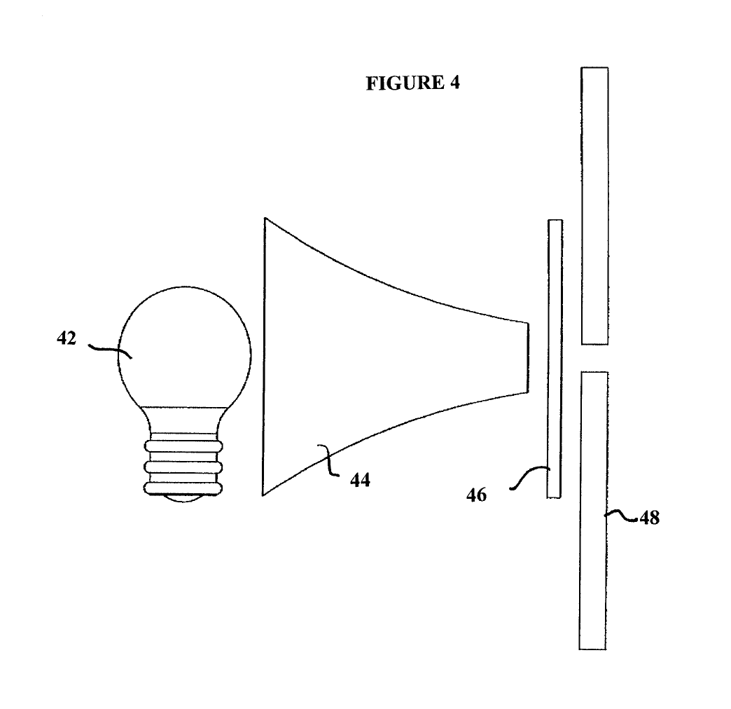

FIG. 4 illustrates an embodiment of a light source incorporating a filter which may be used in conjunction with the present invention. As illustrated, a broad bandwidth light source 42 delivers light via a fiber optic bundle 44 through a band pass optical filter 46 and then through a collimating aperture 48.

Examples of light filters that may be used to prevent light other than light falling within the absorption spectrum of the storage layer radiation screen from reaching the screen include glass filters with multilayer coatings which provide transmission at the desired wavelength, and reject other wavelengths, and colored glass which may also be coated. For example, in the preferred embodiment, the filters should transmit wavelengths in the 400 nm range, while rejecting all others, particularly at 670 nm and in the infrared since the preferred silicon-based detector is also sensitive to infrared. Preferred filters exhibit transmission at the emission wavelength of at least 80% while transmitting one part in 10⁸ at the excitation wavelength and in the infrared regime.

Unlike other storage layer radiation screen reading systems which typically generate a point of light that is scanned relative to the screen, the apparatus of the present invention delivers a narrow, elongated region of excitation light across the storage layer radiation screen. The elongated region of light serves to simultaneously excite a narrow strip of the storage layer radiation screen at the same time. The elongated region of excitation light preferably has a width of less than 100 μm, or 80 μm, or 40 μm. This allows the elongated region to excite as little as a one pixel wide row at a time.

It is noted that although the region is described as being elongated, it should be understood that elongated is intended to signify that the smaller dimension (e.g. width) of the elongated region is roughly uniform across the longer dimension (e.g., length) of the region. Variations in the width of the region such that the elongated sides are not perfectly linear are less preferred but do not cause the region to be outside of the definition of an elongated region. It is also noted that the precise shape of the opposing narrow ends of the region need not necessarily be straight and/or parallel to each other. Rather, the shape of the region should be judged based on the shape of the elongated sides of the region.

The storage layer radiation screen is read by moving the screen from the proximal side 13 to distal side 17 of the platform 12 past the excitation and image acquisition station 18. As the screen moves past the excitation and image acquisition station 18, successive narrow strips of the screen move into contact with the elongated region of excitation light. It is there that the narrow strips are excited and energy from the screen is released.

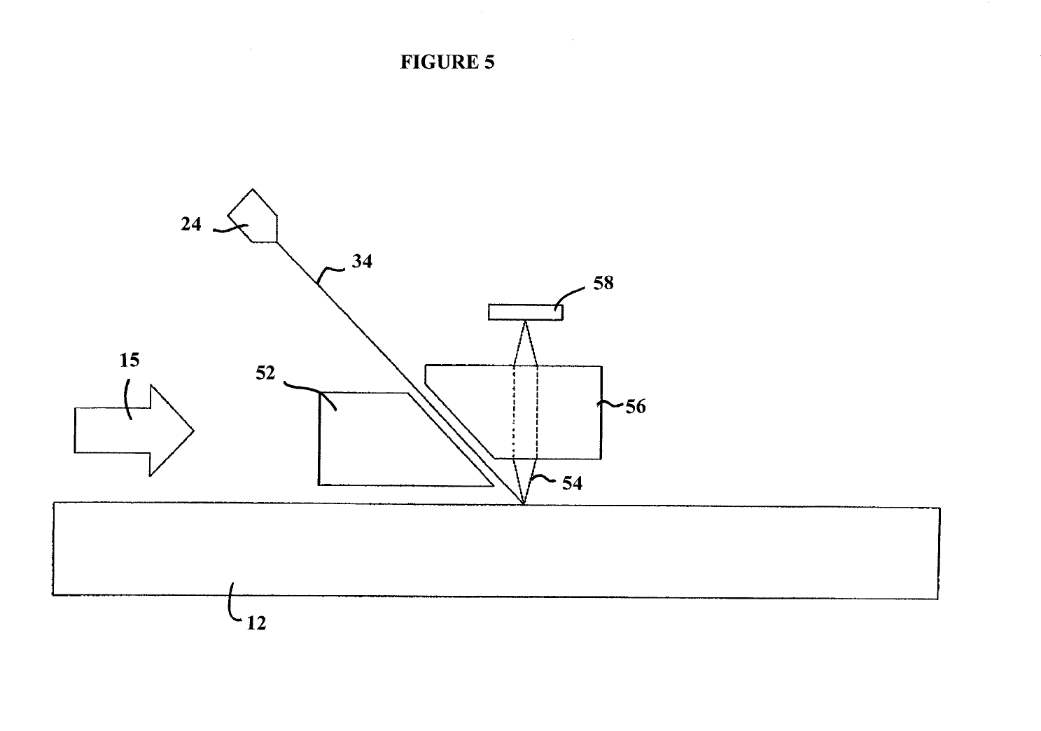

The elongated region of excitation light can be seen in greater detail in FIG. 5 where the light source 24 is shown to produce a line of excitation light 34 across the platform 12 in a direction perpendicular to the direction 15 that the storage layer radiation screen moves relative to the platform 12.

A collimating flange 52 serves to ensure that the leading edge of the light line where it contacts the imaging plate positioned beneath the flange 52 is sharp and does not impinge the imaging plate ahead of the field of view of optics 54 (such as a SELFOC fiber array) which collect emission light 56 from the imaging plate. A pixelated detector 58 is positioned relative to the optics 54 to capture emission light from the imaging plate captured by the optics 54.

A variety of different light sources may be used to generate the excitation energy. For example, different types of light sources that may be used to generate the excitation energy include, but are not limited to a line generator, holographic optic, rotating prism, cold cathode fluorescent lamp (CCFL), cylindrical lens and a row of light emitting diodes.

In one particular embodiment, the light source comprises a laser diode which emits light at wavelengths centered around 670 nm. A line generator is used to generate a fairly uniform line of radiation. Independent sensors can be used to calibrate for temporal fluctuations of the laser intensity. A flange is used to ensure that the leading edge of the light line is sharp and does not impinge the imaging plate ahead of the field of view of the optics and the pixelated detector.

In order to stimulate emission uniformly, the intensity across the elongated region should be uniform. In large measure, this is accomplished by the line generator. A reference image may be stored and used to correct any fixed non-uniformities in the system, including the excitation line.

As will be described herein in greater detail, one aspect of the present invention is the use of a pixelated sensor array such as a line detector 38 to simultaneously record emissions from a narrow strip of the storage layer radiation screen at the same time. The use of a uniform line or an approximately rectangular region of excitation light to excite a narrow strip of the screen serves as a compliment to the use of a pixelated sensor array.

In one variation, the pixelated sensor array is a CMOS sensor array which provides detection of an array of m×n pixels, where m is 1, 2, 3, 4, 5, 6, 7, 8, 9, 10 or more pixels wide and n is greater than 1 and larger than m. In one variation, n is at least 2048. In particular variations, m=1 or 2 and n is at least 2048.

One or more CMOS sensor arrays may be aligned in a row to detect the emissions from the narrow strip of the storage layer radiation screen at the same time.

By contrast to other photodetectors which have been commonly used for detecting radiation from storage layer radiation screen (e.g., cooled metal silicon, avalanche photo diode, photo multiplier tube (PMT) and pin diode) CMOS sensor arrays are advantageous in the apparatus of the present invention.

In the present invention, a set of m×n CMOS arrays may be used where m is most typically equal to 1 or 2. Depending on the spatial resolution desired, n can range from approximately 2600 to over 6000, with the preferred embodiment for the present invention being 3072, corresponding to an 85 μm center-to-center pixel spacing.

The CMOS sensor array may be optimized for detection of emitted photons (approximately 400 nm wavelength) by thinning the passivating layer on the array. This has the serendipitous effect of also reducing sensitivity to the excitation wavelength (typically around 670 nm).

It is desirable for the CMOS sensor array to exhibit noise in the range of 20 electrons/pixel/read. It is also desirable for the CMOS sensor array to exhibit a response which is linear with light intensity and have a high dynamic range (at least 4000:1). It is also desirable for the CMOS sensor array to integrate for a specified period of time, and be able to be read out in a time equal or less than approximately 5% of the integration time.

The process of scanning storage layer radiation screens is destructive because the portion of the screen excited releases energy in the form of light to be detected. According to the present invention, a large portion, if not most of the energy stored on the screen is preferably released, collected and captured during a reading.

Giver the destructive nature of scanning storage layer radiation screens, it is thus important to have only the portion of the screen which is being read to come into contact with the excitation light. In order to accomplish this, it is important to carefully and selectively deliver excitation light to a narrow strip of the storage layer radiation screen. Light emitted from this narrow strip is then recorded by the line detector 38.

For mammographic applications, the excitation region should not exceed the field of view of the optics and the sensor. In this regard, care should be made to have the leading edge of the excitation line be sharp and arranged such that the screen is not exposed ahead of the field of view of the sensor. In one variation, the width of the excitation region is less than 100 μm and in a particular variation may be approximately 85 μm.

The architecture of the excitation and image acquisition station 18 serves, at least in part, to control how light from the light source 24 contacts the storage layer radiation screen so that only a narrow strip of pixels on the screen are excited at any given time. FIG. 5 provides a close-up view of the excitation and image acquisition station 18 shown in FIGS. 1 and 2. As can be seen in FIGS. 1 and 5, a flange 32 extends across the platform 12 perpendicular to the direction which the storage layer radiation screen moves relative to the platform 12. Flange 32 serves as an overhang above the excitation and image acquisition station 18 to define a distal front 34 of the excitation light produced by the light source 24. Meanwhile, the architecture of the device is also such that the leading edge of the excitation light is kept sharp to prohibit premature excitation of the phosphor layer.

When excitation light contacts the narrow strip on the storage layer radiation screen, the luminophores stored in the screen emit light at a different wavelength (typically between 390 nm and 440 nm for storage layer phosphor screens) than the range of wavelengths used to excite the screen.

As illustrated in FIGS. 1 and 5, positioned above where light contacts the screen are optics 40 which collect light emissions from the narrow strip. These optics then convey the light to the line detector, which is preferably a CMOS sensor array 38.

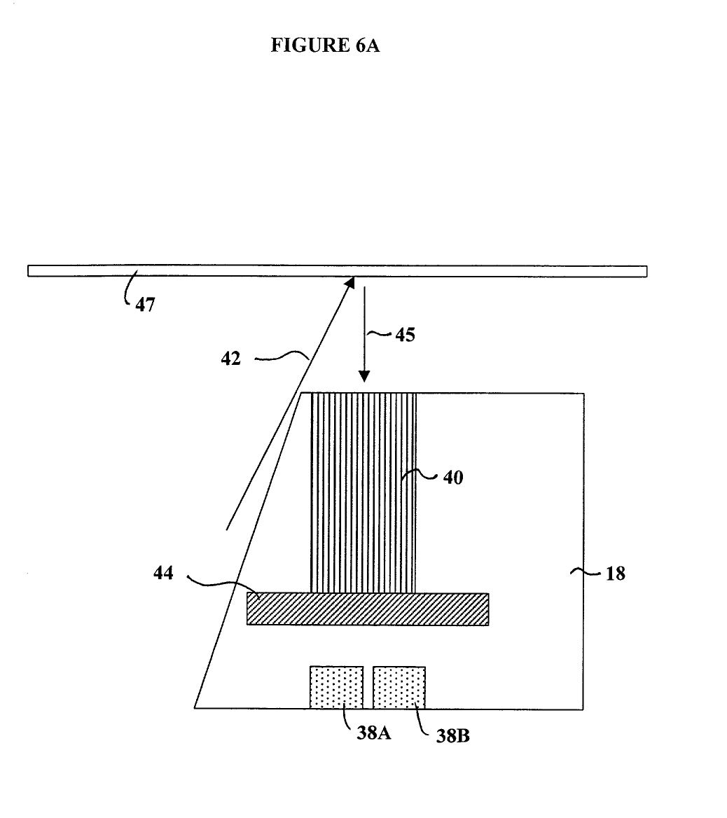

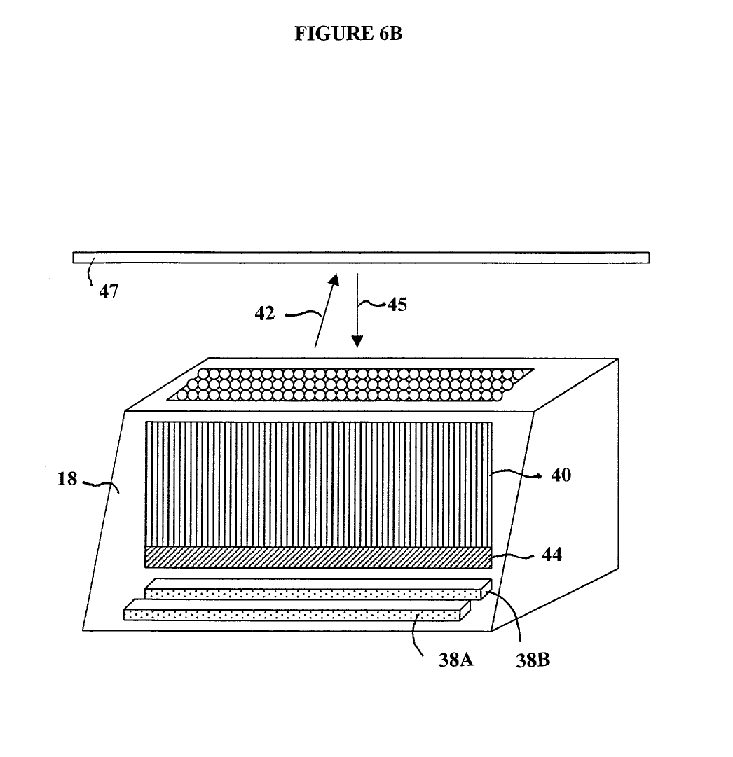

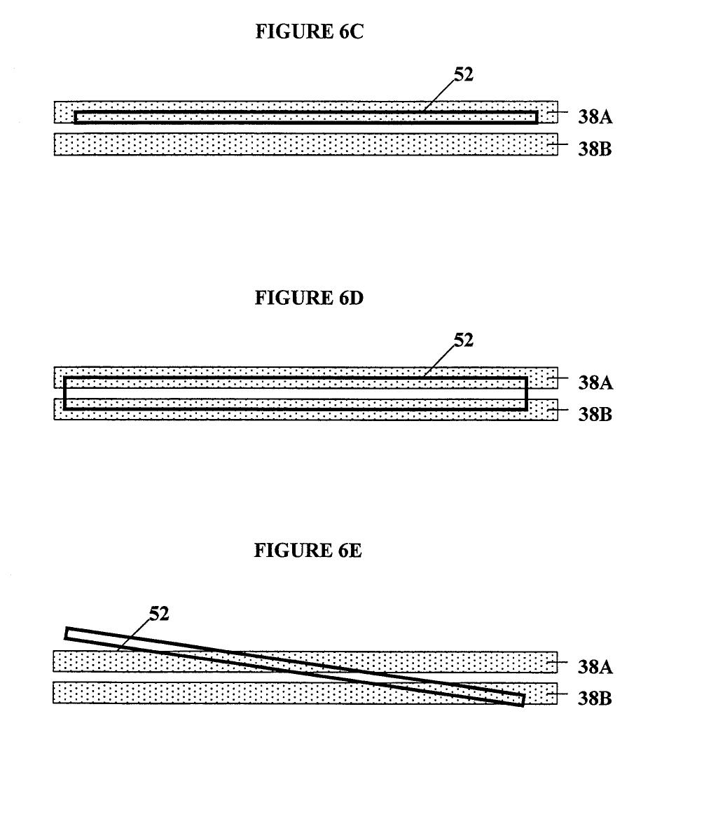

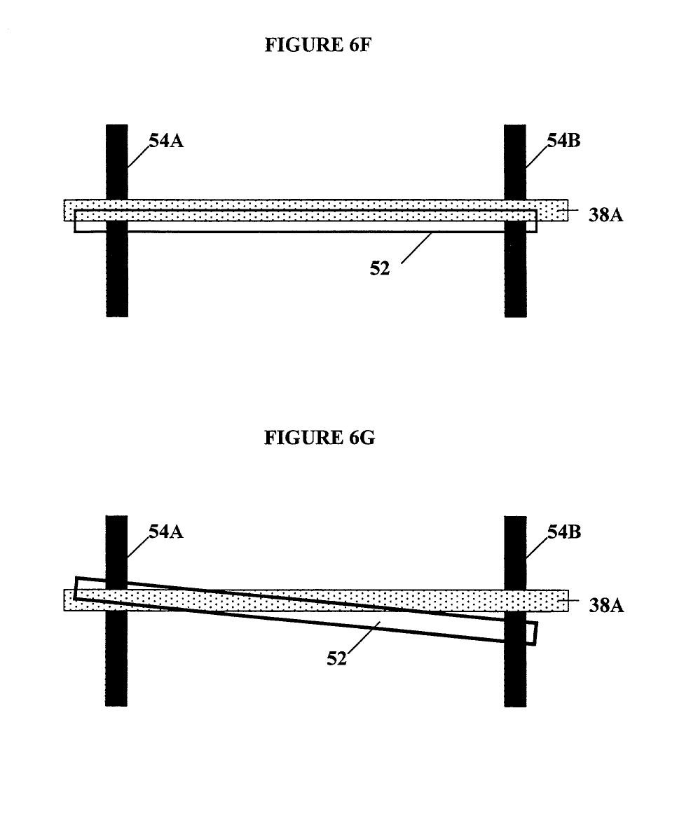

FIGS. 6A and 6B illustrate an embodiment of an excitation and image acquisition station 18. As illustrated, the station comprises two separate line detectors (two CMOS sensor arrays 38A, 38B), an optical filter 44 and optics 40. In operation, excitation light 42 is directed toward the storage layer screen 42 and excites a narrow strip of a screen 47. As a result, the narrow strip of the screen emits light 45 corresponding to the stored latent image. The light emitted is collected by optics 40. A filter 44 is used to prevent light, other than light emitted by the screen, from reaching the CMOS sensor arrays 38A, 38B. Light which passes through the filter is then collected by one of the CMOS sensor arrays 38A.

As the screen moves along the platform 12, successive narrow strips of the screen come into contact with the excitation light 42. As a result, light is emitted from the successive narrow strips over time and captured by the CMOS sensor array 38A. By monitoring what light is captured by each CMOS element in the array over time, one is able to reconstruct the latent image that was recorded on the storage layer radiation screen.

The light captured by the CMOS sensor array is ultimately converted into electrical signals. The electrical signals produced by the CMOS sensor array are communicated to a data processing system which assembles the data collected and provides the user with one or more outputs corresponding to the image stored on the screen. For example, the data processing system can be connected to a data storage device (floppy disc, hard drive, floptical), an image reproducing device (monitor, printer), as well as a variety of communication devices (modem, network). The data processing system also enables the data collected to be manipulated by the user.

As illustrated in FIGS. 6A and 6B, the CMOS sensor array used as the detector preferably has a footprint that is sized to detect light emitted across the width of the screen. Since the CMOS sensor array may only be a single row wide, it is important that only a narrow strip of the screen be excited by the excitation light. This serves to preserve a 1:1 correlation between the light emitted by the screen and the light collected by the CMOS sensor array and avoids prematurely erasing the stored latent image.

Only one of the two line CMOS sensor arrays (e.g., 38A) shown in FIGS. 6A and 6B are actually needed in order to detect the light emitted by the row of pixels. The second CMOS sensor array (e.g., 38B) may be employed to test and confirm alignment of the first line CMOS sensor array 38A with the light emitted by the narrow strip of the screen.

FIGS. 6C, 6D, and 6E illustrate instances where the first line CMOS sensor array 38A is (FIGS. 6C, 6D) and is not (FIG. 6E) aligned with the light 52 emitted by the narrow strip of the screen. As can be seen in FIGS. 6C and 6D, when the light 52 emitted by the narrow strip of the screen is aligned with the first CMOS sensor array 38A, the light 52 either does not contact the second CMOS sensor array 38B (FIG. 6C) or contacts the second CMOS sensor array 38B approximately uniformly across the array (FIG. 6D). As can be seen in FIG. 6E, when the light emitted by the narrow strip is not aligned with the first CMOS sensor array 38A, the light only contacts one side of the second CMOS sensor array 38B. This enables the misalignment to be rapidly detected.

FIGS. 6F and 6G illustrate an alternate embodiment for detecting misalignments in which only a single CMOS sensor array 38A is used. In this instance, detectors 54A and 54B are positioned on opposing sides of the CMOS sensor array 38A which are perpendicular to the array. By checking to see whether light emitted by the narrow strip is detected at a same distance away from the CMOS sensor array 38A on both sides of the CMOS sensor array 38A, one is also able to check alignment.

In the manufacture and assembly of scanning systems, slight misalignments are difficult to avoid. Further, misalignments may occur during the course of operation and due to shocks (hits, droppings, etc.) to the system. The use of two CMOS sensor arrays 38A and 38B as shown in FIGS. 6A and 6B, or the use of a single CMOS sensor array in combination with other detectors as shown in FIGS. 6F and 6G, enable one to rapidly detect when such misalignments are present so that the misalignments can be adjusted.

As noted above, breast imaging is the most demanding of the various medical imaging procedures. In order to achieve a desired high level of image resolution, it is important to efficiently collect and capture as much light as possible that is emitted from the storage layer radiation screen.

One feature of the present invention is the use of an array of optical elements to collect and focus light emitted by the storage layer radiation screen and convey that light to the line detector, preferably a CMOS sensor array. The array of lenses are preferably 2 elements wide in the direction which the screen moves along the platform.

In one preferred embodiment, the array of optical elements comprises graded index of refraction (GRIN) fibers. GRIN fibers advantageously collect light and focus light into an image on their output side. An array of these fibers acts together as a lens which can be configured in a linear shape and can perform efficiently, for example with an f/# less than 1. Preferred specifications for the GRIN fibers include an f/# of approximately 0.9, light transmission efficiency of better than 80% at the emission wavelength of the storage phosphor. The focal length should be compatible with the mechanical constraints of the excitation and detection station. The refractive index ranges from approximately 1.6 at the center of the fiber out to approximately 1.4 at the surface.

In order to achieve a desired high level of image resolution, it is also important to prevent light other than the light emitted from the storage layer radiation screen from reaching the detector. In order to accomplish this, a light filter 44 is positioned between the array of lenses and the line detector. The filter should transmit at least 80% of the light at the emission wavelength. Attenuation of the excitation wavelength and infrared should be better than 10⁸.

In order to further reduce the amount of extraneous light which reaches the line detector, it is desirable to block other potential light paths.

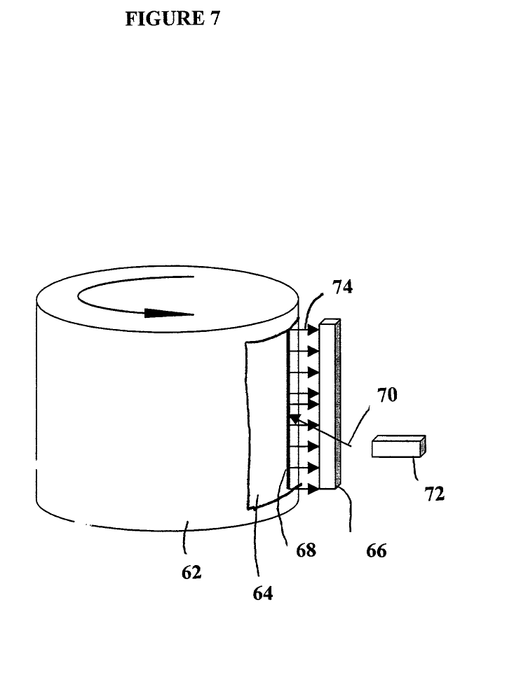

The apparatus described in regard to FIGS. 1 and 2 may also employ an area detector (e.g., a m×n sensor where m>1) instead of the 1×n line sensor described previously. The area detector may be a charge-coupled device (CCD) or an area CMOS sensor. In this case, the excitation light would be configured so that the area of illumination and the accompanying scatter regions within the storage layer screen correspond to the field of view of the area sensor. The image is acquired as a series of area excitations which may overlap to some degree and which are combined to form the entire image. It is noted that the apparatus described in regard to FIGS. 1 and 2 is a flat bed scanner. However, the apparatus can be readily modified to be a drum scanner. FIG. 7 illustrates an embodiment of a drum scanner according to the present invention. As illustrated, a rotatable drum 62 is employed in place of a platform and roller assembly. A storage layer radiation screen 64 is affixed to a surface of the drum 62. An excitation and image acquisition station 66 is positioned adjacent the drum 62 such that rotation of the drum causes the screen 64 to move relative the station 66. As illustrated, a line 68 of excitation light 70 from light source 72 is directed toward the drum 62 and excites a narrow strip of the screen 64. As a result, the narrow strip of screen emits light 74 corresponding to the stored latent image. The light emitted is collected by optics and delivered to a line detector incorporated within the excitation and image acquisition station 66.

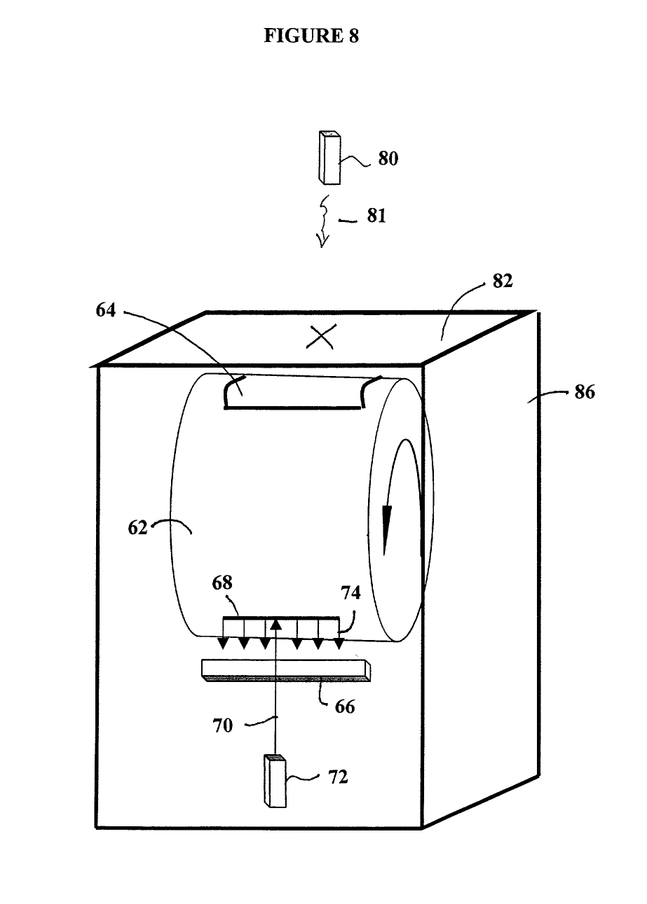

In another embodiment, storage layer radiation screens are not added to the apparatus but rather are incorporated into the apparatus. FIG. 8 illustrates an embodiment of the invention which comprises a radiation source 80, a platform 82 on which a breast may be positioned, and an apparatus 86 according to the present invention. In this instance, the apparatus 86 is a rotatable drum scanner such as the one shown in FIG. 7. According to this embodiment, when a breast is placed on the platform 82, the radiation source 90 can be caused to irradiate 81 the breast (“X”) as well as a storage layer radiation screen 64 positioned beneath the platform. Once irradiated, the storage layer radiation screen 64 may be moved to be read within the apparatus 86.

As can be seen from FIG. 8, an attractive feature of the apparatus of the present invention is its ability to be used in conjunction with retrofitting existing mammography devices. For example, as shown in FIG. 8, the apparatus according to the present invention can be positioned beneath existing mammography devices such that the storage layer radiation screen is positioned where traditional x-ray film is currently positioned on such devices.

It will be apparent to those skilled in the art that various modifications and variations can tie made in the compounds, compositions, kits, and methods of the present without departing from the spirit or scope of the invention. Thus, it is intended that the present invention cover the modifications and variations of this invention provided they come within the scope of the appended claims and their equivalents.

What is claimed is:

1. An apparatus for reading a latent image stored on a storage layer radiation screen, the apparatus comprising:
a light source adapted to provide excitation light across a width of a storage layer radiation screen; and
an excitation and image acquisition station comprising a mechanism for shaping the excitation light as an elongated region of excitation light across the width of the screen, optics for collecting a region of light emitted by a lateral strip of the screen excited by the elongated region of excitation light, and an elongated pixelated sensor array positioned to capture from the optics the region of light emitted by the screen;
wherein the latent image stored on the screen is read by collecting and capturing light emitted from the screen as the screen moves past the excitation and image acquisition station.

2. An apparatus according to claim 1 wherein the elongated pixelated sensor array is a 1×n array where n is greater than 1.

3. An apparatus according to claim 1 wherein the elongated pixelated sensor array is a m×n array where m and n are each greater than 1.

4. An apparatus according to claim 1 wherein the elongated pixelated sensor array comprises an array of 1×n pixels where n is at least 2048.

5. An apparatus according to claim 1 wherein the elongated pixelated sensor array comprises an array of m×n pixels where m is at least 2 and n is at least 2048.

6. An apparatus according to claim 1 wherein the elongated pixelated sensor array is a CMOS sensor array.

7. An apparatus according to claim 1 wherein the elongated pixelated sensor array is a CMOS sensor array optimized for detection of light at the emission wavelength.

8. An apparatus according to claim 1 wherein the elongated pixelated sensor array is a CMOS sensor array optimized such that its sensitivity to the excitation wavelength and infrared is minimized.

9. An apparatus according to claim 1 wherein the excitation and image acquisition station comprises at least two CMOS sensor arrays positioned in parallel with each other, at least one of which serving as the elongated pixelated sensor array.

10. An apparatus according to claim 1 wherein the excitation and image acquisition station comprises at least two CMOS sensor arrays positioned in parallel with each other, at least one of which serving as the elongated pixelated sensor array, the region of light collected by the optics being focused upon at least one of the two CMOS sensor arrays.

11. An apparatus according to claim 1 wherein the excitation and image acquisition station comprises at least two CMOS sensor arrays positioned in parallel with each other, at least one of which serving as the elongated pixelated sensor array, the region of light collected by the optics being focused upon the at least two CMOS sensor arrays.

12. An apparatus according to claim 1 wherein the pixelated sensor array is a CMOS sensor array, the excitation and image acquisition station further comprising a filter which filters light other than light emitted by the screen from the CMOS sensor array.

13. An apparatus according to claim 1 wherein the mechanism for causing the screen to move relative to the platform is a roller assembly.

14. An apparatus according to claim 1 wherein the mechanism for causing the screen to move relative to the platform is a belt.

15. An apparatus according to claim 1 wherein the light source is a broad band light source.

16. An apparatus according to claim 15 wherein a filter is employed with the broad band light source which removes light that does not fall within a wavelength range of an absorption spectrum of the screen.

17. An apparatus according to claim 1 wherein the excitation light contacting the screen comprises the wavelength range of 650 to 680 nanometers.

18. An apparatus according to claim 1 wherein the light source comprises a member of the group consisting of a line generator, holographic optic, rotating prism, cold cathode fluorescent lamp, cylindrical lens and a row of light emitting diodes.

19. An apparatus according to claim 1 wherein the excitation and image acquisition station excites a lateral strip of the screen having of width of less than 100 μm at any instant.

20. An apparatus according to claim 1 wherein the excitation and image acquisition station excites a lateral strip of the screen having of width of less than 80 μm at any instant.

21. An apparatus according to claim 1 wherein the excitation and image acquisition station comprises a flange which functions to narrow a width of the region of excitation light formed across the width of the screen.

22. An apparatus according to claim 1 wherein the excitation and image acquisition station comprises a cylindrical lens which functions to sharpen the focus of the excitation light.

23. An apparatus according to claim 1 wherein the excitation and image acquisition station comprises a flange which functions to create a sharp leading edge of the excitation light.

24. An apparatus according to claim 1 wherein the optics of the excitation and image acquisition station comprises an array of gradient index fibers.

25. An apparatus according to claim 1 wherein the optics of the excitation and image acquisition station comprises an array of gradient index fibers, the array being at least 2 fibers wide in the direction which the screen is moved.

26. An apparatus according to claim 1 wherein the optics of the excitation and image acquisition station comprises an array of gradient index lenses, the array being at least 3 lenses wide in the direction which the screen is moved.

27. An apparatus for reading a latent image stored on a storage layer radiation screen, the apparatus comprising:
a platform comprising a mechanism for causing a storage layer radiation screen comprising a latent radiation image to move from a proximal side to a distal side of the platform;
a light source adapted to provide excitation light across a width of the screen; and
an excitation and image acquisition station positioned adjacent the platform, the station comprising a mechanism for shaping the excitation light as an elongated region of excitation light across the width of the screen, optics for collecting a region of light emitted by a lateral strip of the screen excited by the elongated region of excitation light, and an elongated pixelated sensor array positioned to capture from the optics the region of light emitted by the screen;
wherein the latent image stored on the screen is read by collecting and capturing light emitted from the screen as the screen moves past the excitation and image acquisition station.

28. An apparatus for reading a latent image stored on a storage layer radiation screen, the apparatus comprising:
a rotatable drum on which a storage layer radiation screen comprising a latent radiation image may be positioned;
a light source adapted to provide excitation light across a width of the screen; and
an excitation and image acquisition station positioned adjacent the rotatable drum, the station comprising a mechanism for shaping the excitation light as an elongated region of excitation light across the width of the screen, optics for collecting a region of light emitted by a lateral strip of the screen excited by the elongated region of excitation light, and an elongated pixelated sensor array positioned to capture from the optics the region of light emitted by the screen;
wherein the latent image stored on the screen is read by collecting and capturing light emitted from the screen as the rotatable drum rotates and causes the screen to move past the excitation and image acquisition station.

29. An apparatus for reading a latent image stored on a storage layer radiation screen, the apparatus comprising:
a platform comprising a mechanism for causing a storage layer radiation screen comprising a latent radiation image to move from a proximal side to a distal side of the platform;
a light source adapted to provide excitation light across a width of the screen; and
an excitation and image acquisition station positioned adjacent the platform, the station comprising a mechanism for shaping the excitation light as a region of excitation light across the width of the screen, optics for collecting the light emitted by a corresponding region of the screen excited by the region of excitation light, and an m×n pixelated sensor array positioned to capture from the optics the region of light emitted by the screen;
wherein the latent image stored on the screen is read by collecting and capturing light emitted from the screen as the screen moves past the excitation and image acquisition station in a time-delay integration mode.

30. An apparatus for reading a latent image stored on a storage layer radiation screen, the apparatus comprising:
a platform comprising a mechanism for causing a storage layer radiation screen comprising a latent radiation image to move from a proximal side to a distal side of the platform;
a light source adapted to provide excitation light across a width of the screen; and
an excitation and image acquisition station positioned adjacent the platform, the station comprising a mechanism for shaping the excitation light as a region of excitation light across the width of the screen, optics for collecting the light emitted by a corresponding region of the screen excited by the region of excitation light, and an m×n pixelated sensor array positioned to capture from the optics the region of light emitted by the screen;
wherein the latent image stored on the screen is read by capturing light emitted from the screen as the screen moves past the excitation and image acquisition station in a step-and-repeat mode.

31. A method for reading a latent image stored on a storage layer radiation screen, the method comprising:
delivering an elongated region of excitation light;
moving a storage layer radiation screen past the elongated region of excitation light, the excitation light causing light to be emitted from the screen corresponding to portions of the latent image stored on the screen;
employing optics to collect light emitted from the storage layer radiation screen as the screen is moved past the elongated region of excitation light; and
focusing the collected light from the optics on an elongated pixelated sensor array positioned to capture from the optics the region of light emitted by the screen.

32. A method according to claim 31 wherein the elongated pixelated sensor array is a 1×n array where n is greater than 1.

33. A method according to claim 31 wherein the elongated pixelated sensor array is a m×n array where m and n are each greater than 1.

34. A method according to claim 31 wherein the elongated pixelated sensor array comprises an array of 1×n pixels where n is at least 2048.

35. A method according to claim 31 wherein the elongated pixelated sensor array comprises an array of m×n pixels where m is at least 2 and n is at least 2048.

36. A method according to claim 31 wherein the elongated pixelated sensor array is a CMOS sensor array.

37. A method according to claim 31 wherein the elongated pixelated sensor array is a CMOS sensor array optimized for detection of light at the emission wavelength.

38. A method according to claim 31 wherein the elongated pixelated sensor array is a CMOS sensor array optimized such that its sensitivity to the excitation wavelength and infrared is minimized.

39. A method according to claim 31 wherein the excitation and image acquisition station comprises at least two CMOS sensor arrays positioned in parallel with each other, at least one of which serving as the elongated pixelated sensor array.

40. A method according to claim 31 wherein the excitation and image acquisition station comprises at least two CMOS sensor arrays positioned in parallel with each other, at least one of which serving as the elongated pixelated sensor array, the region of light collected by the optics being focused upon at least one of the two CMOS sensor arrays.

41. A method according to claim 31 wherein the excitation and image acquisition station comprises at least two CMOS sensor arrays positioned in parallel with each other, at least one of which serving as the elongated pixelated sensor array, the region of light collected by the optics being focused upon at least two CMOS sensor arrays.

42. A method according to claim 31 wherein the pixelated sensor array is a CMOS sensor array, the excitation and image acquisition station further comprising a filter which filters light other than light emitted by the screen from the CMOS sensor array.

43. A method according to claim 31 wherein the light source is a broad band light source.

44. A method according to claim 43 wherein a filter is employed with the broad band light source which removes light that does not fall within a wavelength range of an absorption spectrum of the screen.

45. A method according to claim 31 wherein the excitation light contacting the screen comprises the wavelength range of 650 to 680 nanometers.

46. A method according to claim 31 wherein the light source comprises a member of the group consisting of a line generator, holographic optic, rotating prism, cold cathode fluorescent lamp, cylindrical lens and a row of light emitting diodes.

47. A method according to claim 31 wherein the excitation light across the width of the screen has a width of less than 100 μm at any instant.

48. A method according to claim 31 wherein the excitation light across the width of the screen has a width of less than 80 μm at any instant.

49. A method according to claim 31 wherein the excitation light across the width of the screen has a width of less than 60 μm at any instant.

50. A method according to claim 31 wherein the excitation and image acquisition station comprises a flange which functions to narrow a width of the region of excitation light formed across the width of the screen.

51. A method according to claim 31 wherein the excitation and image acquisition station comprises a cylindrical lens which functions to sharpen the focus of the excitation light.

52. A method according to claim 31 wherein the screen is moved past the excitation light by moving the screen over a surface of a platform.

53. A method according to claim 31 wherein the screen is moved past the excitation light by rotating a rotatable drum on which the screen is positioned.

54. A method according to claim 31 wherein the excitation light comprises multiple wavelengths of light within an absorption spectrum of the screen.

55. A method according to claim 31 wherein the excitation light comprises multiple wavelengths of light between 600 nm and 700 nm.

56. A method according to claim 31 wherein the pixelated sensor array has a dynamic range of at least 4000:1.

57. A method according to claim 31 wherein the pixelated sensor array can be read out more quickly than an integration time of the pixelated sensor array.

58. A method according to claim 31 further comprising filtering light from the optics prior to the light contacting the pixelated sensor array so that only light emitted by the screen contacts the pixelated sensor array.
